(19) United States
(12) Patent Application Publication
(10) Pub. No.: US 2004/0221146 A1
(43) Pub. Date: Nov. 4, 2004

(54) Build time dynamic installation of drivers on cloned systems

(75) Inventor: Warren J. Baumann, Monroe, NY (US)

Correspondence Address: John E. Campbell, IBM Corporation, 2455 South Road, P386, Poughkeepsie, NY, 12601, US

(73) Assignee: International Business Machines Corporation, Armonk, NY

(21) Appl. No.: 10/427,390

(22) Filed: Apr. 30, 2003

(51) Int. Cl. G06F 15/177

(52) U.S. Cl. 713/1

(57) ABSTRACT

A replica (clone) image of a computer system comprising an operating system is created. The clone image is loaded at a second computer system. A characteristic (such as computer type or model) of the second computer system is used to select a list of components such as device drivers appropriate for the second computer system. Components needed for the second computer system are found using the component list.

### FIELD OF THE INVENTION

The present invention is related to systems, program products and methods for creating replica computer system program images, more particularly to separately providing program components and replica computer system program images.

### BACKGROUND OF THE INVENTION

Organizations have responsibility for supporting diverse computers and work stations. A medium sized organization may have thousands of diverse models and types of computers that need to be managed and maintained to appropriate levels or versions of applications, operating systems and support hardware (drivers). The organization needs to be concerned with availability, serviceability, new installations, maintenance and security.

When adding a computer or workstation, organizations often supply a standard computer system “image” of software (including an Operating System) to the new computer. The image must be customized according to machine type, model and peripheral attachments. The image may also be customized to provide a set of applications and hardware drivers. This allows the organization to maintain a reduced set of images for all of the computers that need to be supported. Even with this technique, the number of images can be large and each image may be large as easily can be seen by the fact that an image must include all of the driver programs that a computer or workstation may need. Managing a large number of versions is a logistics problem but having large numbers of large images creates a need for large storage. Distributing the large images by way of a network is time consuming especially when the network includes a slow protocol or when there is high demand for the network.

Native installation of operating systems and applications can be time consuming and error prone. Realizing this, companies such as PowerQuest and Symantec have developed disk imaging software that takes a “snap shot” of a computer system image and saves it to a file(s). The “snap shots” can be saved on a server and distributed to new clients by way of a network. The saved “snap shot ” is a “clone” or “replica” image of the computer system image. The “snap shot” can then be used by other computers by loading the “snap shot” into another identical computer (cloning).

Cloning of a computer image is the process of configuring a master computer system with a specific operating system and set of application programs supporting a specific set of peripheral devices and copying (cloning) the “program image” of this configuration to other (cloned) computer systems. The copied image is a clone of the master computer system image.

Thus, all of the systems cloned have common software (with the same levels and versions of the same software). Cloning simplifies an organization's IT infrastructure since all of the computers or workstations have the same software. A problem exists with this strategy since a separate clone image must be created to support different computer types and models, hardware configuration differences, device drivers and the like.

Because of its ease of use and fast speed, cloning has solidified its place in the industry by allowing companies to simplify client deployment and reduce costs by putting a client standardization effort in place.

Referring to FIG. 3, an example cloning process is shown. A client 1 301 computer system is configured to represent the desired clone system. It comprises a characteristic machine type/model (TX1) 305, a desired operating system (OS) 302, optional applications 303, desired drivers 306 and desired configuration information 304. The image of client 1 is then captured and stored as Image2 318 in a server 316 storage area. The Server 316 holds N images. Client 2 307 is to be built. Since the machine type is TB2, desired image2 is deemed appropriate so it is loaded into the client2 307 via a network connection 321 or CD. Thus, client 2 307 becomes a clone of client1 301. The server may support cloning of other computers 312, each one having to select the appropriate image stored in the server 316.

Current cloning software does not address the issue of adding new hardware/driver support to an existing image file. Since imaging systems (cloning) requires that the target system 307 and the source system 301 be exactly the same, large enterprises can sometimes have hundreds or even thousands of cloned images 317-219 on their servers 316 in order to have a cloned image for each supported system configuration. Some operating systems, like windows 2000/XP from MICROSOFT CORP., have imaging tools that allow a technician to reset the devices that had been previously detected by the operating system. By resetting the devices, the operating system can re-scan for hardware on the next boot of the operating system. Using this method, in a cloned system, requires managing the plug and play driver repository on the cloned system. In order to create a new clone image 318, the technician would clone a known image file 317 containing an operating system with installed and customized applications to a system, boot the operating system, manipulate the driver repository 306 that resides on the client 301 to include new or updated drivers, run the imaging tool, then clone the system image back to the server 316. When the technician saves the “cloned client system” to the server, the technician is saving a snapshot of the operating system 302, applications 303, and hardware support components 304. The snapshot is a version of the computers' operating system that can be cloned (replicated) to other systems that are supported by the updated driver repository 306 or native driver support built into the operating system.

This method isn't without its problems. Plug and play systems force the image to use the latest available driver in the repository where the organization would prefer to have a predetermined version of the driver. Also, updating and adding drivers to the base can be tedious, time consuming, and error prone.

Microsoft Windows 2000/XP system Preparation Tool (Imaging Tool):

The Windows 2000 System Preparation Tool (Sysprep) enables administrators to prepare Windows 2000 System Images as part of an automated deployment. Sysprep provides the ability to reduce the number of images required in a deployment by supporting multiple mass storage controllers. Sysprep supports cloning of a computer system's Operating System, Software and settings to create an image that can be deployed to numerous target servers or workstations. If the target system has different capability, Plug and Play drivers are loaded when the target system is powered up.

Sysprep is designed to create an image file that can be cloned to computers having similar characteristics (type/models). An enterprise may take one image file and add support to thousands of type/models by updating the driver repository on the target system (under c:\pnp). A problem with this scenario is with the difficulty of maintenance of that driver repository.

### SUMMARY OF THE INVENTION

The present invention comprises a cloning process where specific drivers for the operating system and specific system type/model being cloned are transferred to the cloned system at build time and include access to the predetermined drivers required to deploy that system. A clone (replica) image of a computer system of the desired type and model is captured, components to be added later are removed from the captured image (the clone image). The image is saved at a server. When a client is introduced that needs to be configured, the clone image corresponding to the new client hardware characteristics is loaded into the client. In a preferred embodiment, the clone image that is to be loaded into the client has no driver software included. This makes the clone image much smaller. A table describing the components (drivers) that are supported and where to get them is also provided to the client. Only a subset of drivers comprising only the needed drivers are loaded to the target (cloned) computer (using driver information in the table) and the target computer is booted with the required drivers.

Before cloning the target system, a cloning preparation tool is configured to look in a predefined location on the primary partition for the driver repository.

The user clones the operating system image to the target system.

After the operating system has been cloned, a program, using the type/model information of the target computer, reads the information (from a server side database or table) about the type/model that is to be built. Included in the information obtained from the server is the particular driver information required to build that type/model as well as the common drivers that are needed on the system.

The program then transfers the necessary driver files to the target computer system partition in the correct driver repository.

The target system is booted and all device drivers are installed at the desired versions.

It is an object of the present invention to create a clone image without components including drivers.

It is also an object of the present invention to provided a subset of available drivers to a cloned image, the subset determined by target computer hardware information, the information comprising type, model or a predefined user input parameter.

It is yet another object of the present invention to provide a program to a target client system wherein the program interrogates the target system hardware information and produces a request to a remote server for a clone image or components (such as drivers) appropriate for the target system.

The above as well as additional objectives, features, and advantages of the present invention will become apparent in the following written description.

### BRIEF DESCRIPTION OF THE DRAWINGS

FIG. 1 is a diagram depicting example components of a computer system;

FIG. 2 is a diagram depicting example components of a client-server network;

FIG. 3 is a diagram depicting example components of cloned systems;

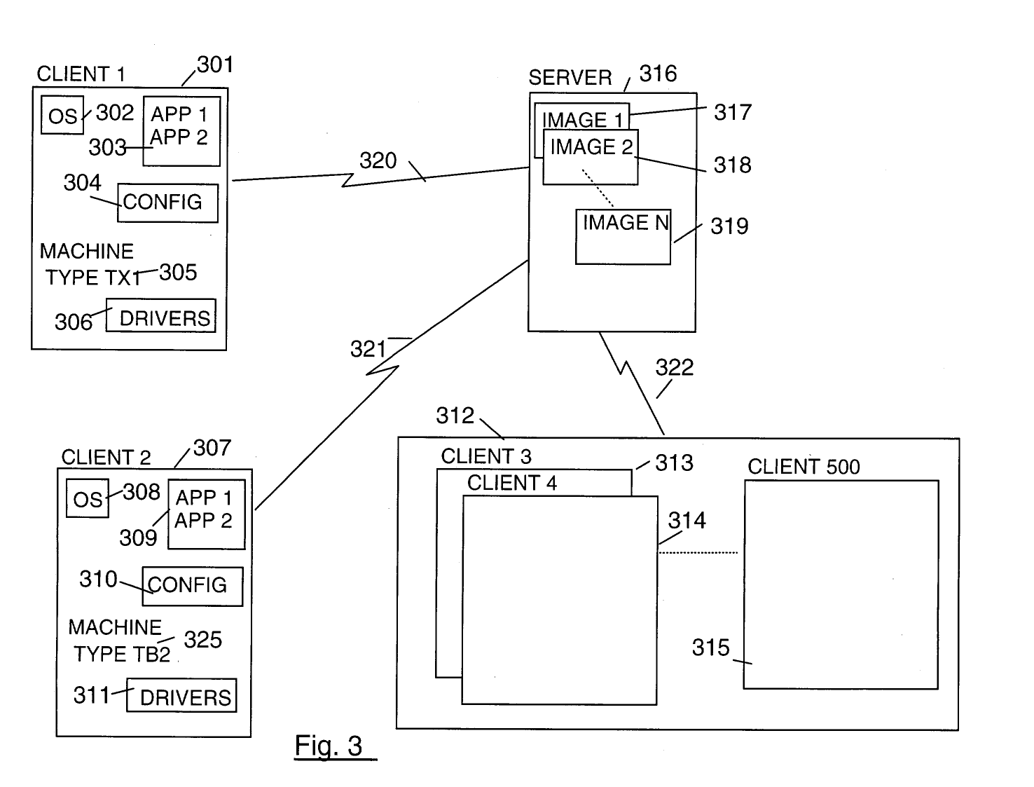

FIG. 4 is a diagram of components of cloned systems of the present invention;

FIG. 5 is a flow chart depicting steps of cloning;

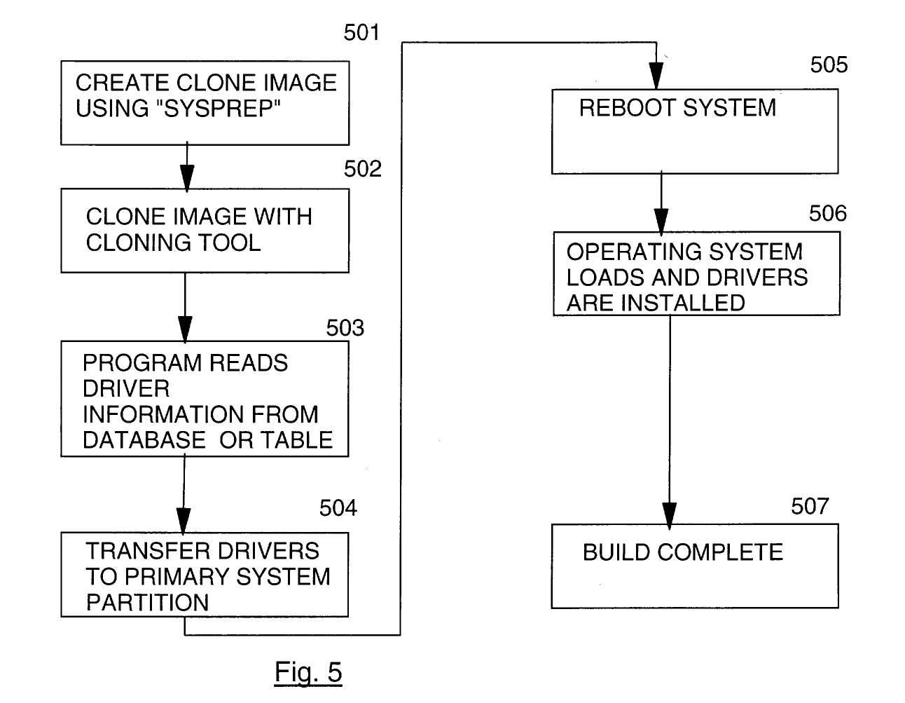

FIG. 6 is a flow chart depicting steps of cloning of the present invention; and

FIG. 7 is a flow chart depicting steps of installing drivers in a cloned system.

### DESCRIPTION OF THE PREFERRED EMBODIMENTS

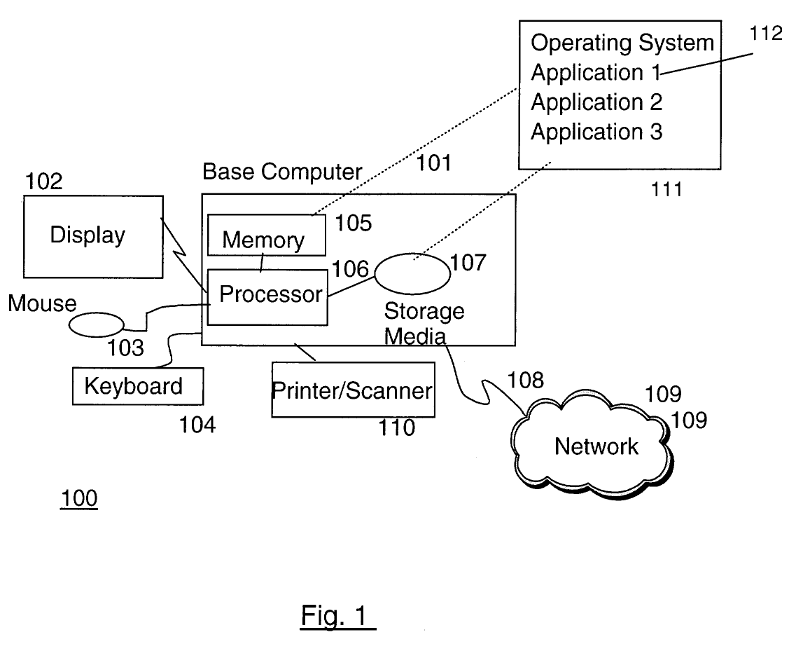

FIG. 1 depicts the elements that make up a typical computer for use in presenting and maintaing an application. The computer 100 consists of a Base Computer 101 which comprises a processor 106, storage media such as a magnetic disk 107 and a high speed volatile main memory 105. An operating system and application programs 111 reside on the storage media 107 and are paged into main memory 105 as needed for computations performed by the processor 106. The Base computer may include optional peripheral devices including a video display 102, a printer or scanner 110, a keyboard 104, a pointing device (mouse) 103 and a connection 108 to a network 109. In a client environment, a user will interact with a (Graphical User Interface) GUI by use of a keyboard 104 and mouse 103 in conjunction with the display of information on the display 102 under control of an application program (application 1) 112. The client application program 112 will then interact with remote users by way of the network 109.

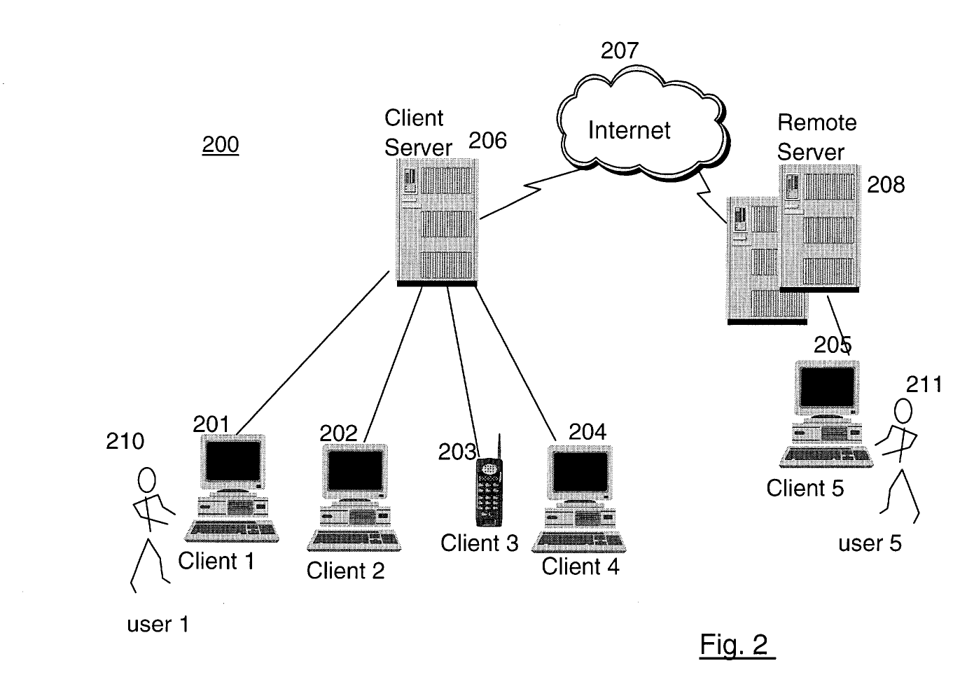

In FIG. 2 an example Internet system is shown. A user 210 at client 1 201 uses applications on his system. This user (user 1 210) at client 1 201 can interact with clients 2-4 202-204 by way of a client server computer 206. Applications 112 may be provided by each client 201-205 and or the client server 206 or some remote server 208 by way of the network 207. The user at client 1 201 can interact with a remote user (user 5 211) at client 5 205 by way of the Internet 207.

One way that computers interact via networks such as the Internet is by using the HyperText Transfer Protocol (HTTP) open standard designed by the World Wide Web Consortium (W3C) and standardized as Internet Engineering Task Force (IETF) RFC 2616. It is an intentionally simple and open protocol that is implemented across many heterogeneous computer systems.

One example of a self configuring computer system is taught in U.S. Pat. No. 5,668,992 “Self-Configuring Computer System” assigned to IBM. This patent is incorporated herein by reference. It describes a self configuring computer system which configures and loads appropriate software to support custom configurations without manual intervention by the user or the manufacturer. When the computer is first activated, an “interrogation” module is loaded that scans the system for components requiring specific software to operate. The interrogation module enables a startup module to select software from disk-based files including the proper version of the operating system. This patent does not discuss such functions as: creating a clone image appropriate for a group of computer systems, providing cloned images to computer systems, providing a separate driver table for finding appropriate drivers for the characteristics of a cloned system, adding drivers to a system so that the operating system's plug and play engine will detect and install the necessary drivers. It also does not address build time dynamic installation of drivers on cloned systems.

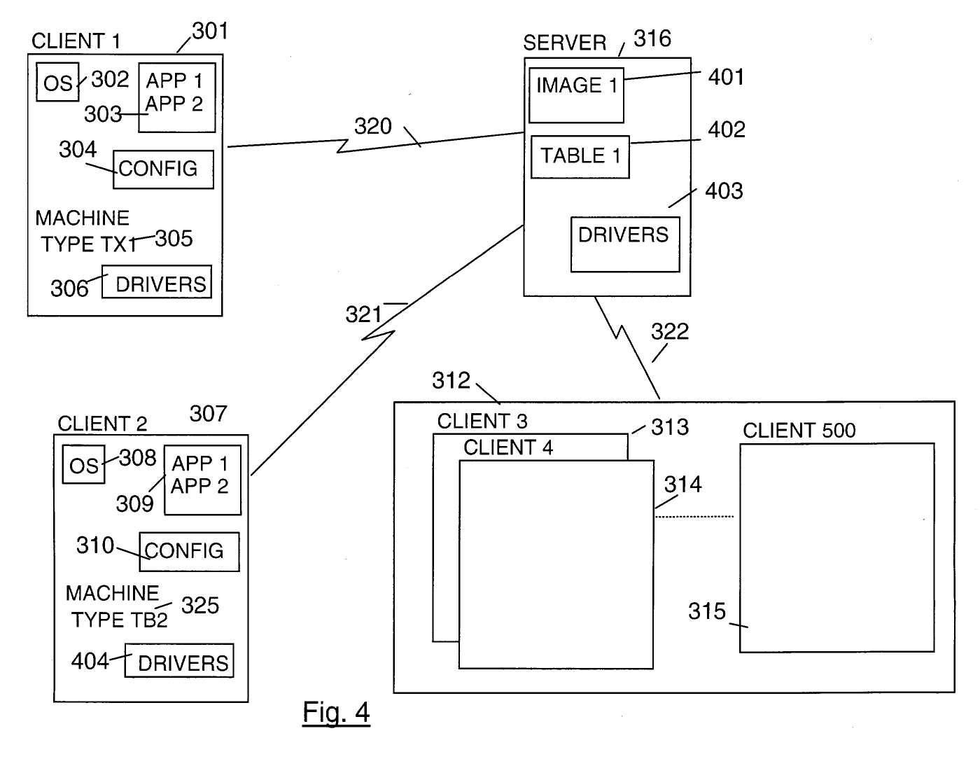

In a preferred embodiment of the present invention (reference FIG. 4), a cloning computer program is provided for creating a replica (clone) computer system program image. A first computer system 301 is prepared for a cloning operation, the preparation configures a computer system 301 that has required characteristics of target computer systems to be replicas. Target computer systems 307 312 will be the recipients of the clone image 401. A component list 402 is also created that contains identifiers identifying desired components such as device drivers for a predefined group of computer systems compatible with the characteristics required. The component list 402 includes a first identifier of a first component. Each identifier may include a component name, the location of where to get the component, the parameters needed to assist a program in retrieving the component, a component version indicator and the like.

A clone image 401 of the prepared first computer system 301 is created that includes an operating system and optionally has some or all of the initial components 306 303 deleted. The clone image 401 is transferred to a second computer system 307. Preferably, a program running at the second system detects the type and model 325 of the second system 307 and requests the appropriate list of components 402 from the first system 301. The component list 402 is sent to the second system 307. The first identifier in the component list is used to locate the first component and insert it into transferred clone image 401 on the second system 307.

We will refer to the new system to be created using a common (cloning) system image 401 as the target system 307. The common (cloning) system image 401 is the cloning image and is defined for an imaginary system we call the template system. Before cloning the target system 307 the cloning preparation tool is configured to look in a predefined location on the primary partition of the target system 307 for the driver repository. The user clones the operating system 302 to the target system 308. After the operating system has been cloned a cloning program reads the information about the target system type/model from the build's dynamically created response file in the target system 307. Included in the information gotten from the response file is the particular driver information required to build that type/model, for example, the common drivers that are needed on the system, system video resolution, and whether the system is multiprocessor capable.

The cloning program transfers the drivers 403 to the primary NTFS preferably using a tool such as “Pqaccd.exe” from PowerQuest. Pqaccd.exe enables one to write to NTFS Partitions. NTFS partitions are ordinarily protected from user access and the PowerQuest tool is able to access these partitions. The image files created are saved as NTFS partitions. Pqaccd.exe is a tool/executable that permits one to edit the protected partition. The program transfers the drivers to the primary NTFS partition in the correct driver repository. FAT, FAT32, and NTFS are different partition/file system types. Different partition/file types (depending on the file system) provide better security, support for larger hard drives, and speed. The PowerQuest tool then edits the driver repository located on the primary partition (adds the driver support). The target system is booted and all device drivers are installed at the desired version, according to the definition for that model/type in the database or table.

Description of File Names Used:

“mtbchknt.exe”—A program written to read the type/model information about a system from an input file then perform actions based on the values in the input file. —This program does most of the work according to the present invention.

“mrf.ini”—the build input file. Generated by selections chosen by the user and type/model specific information retrieved from server.

“config2k.exe”—GUI mode program used to install type/model specific software.

“pqaccd.exe”—A third party tool developed by PowerQuest to write to NTFS partitions.

“sysprep.inf”—control file for the Microsoft Clone Preparation Tool “Sysprep”

“mtb.ini”—master type/model table. Contains the type/model specific build information for ever supported system. During the build process the information stored in this table is transferred to the build response file (mrf.ini).

“c4ebcust”—GUI mode install control program.

“IBM Standard Client Installer (ISCI)”—Build process used by clients deployed within IBM.

The technical details for a preferred implementation are as follows:

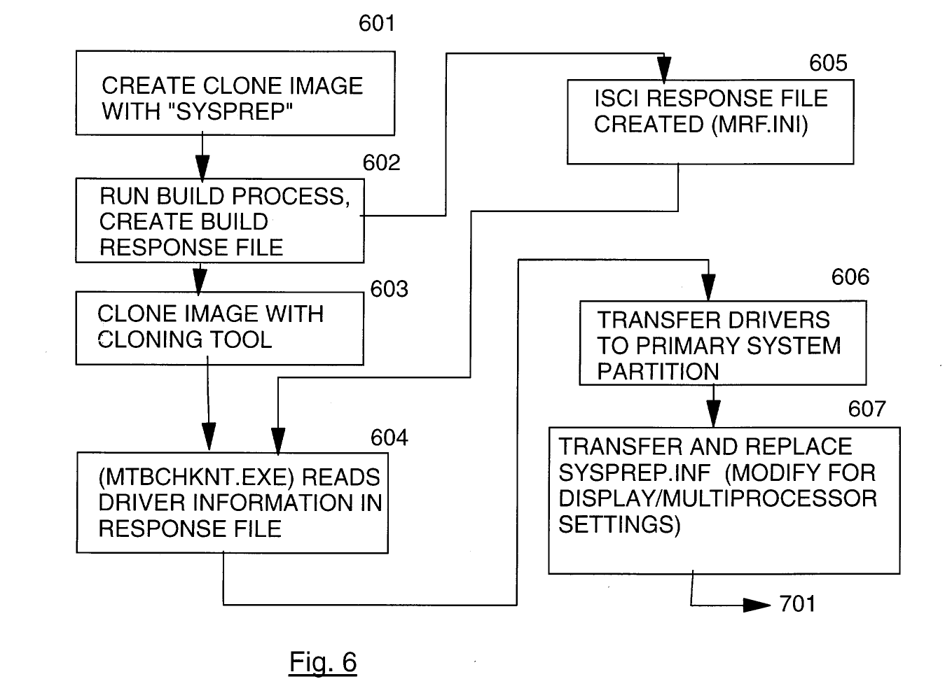

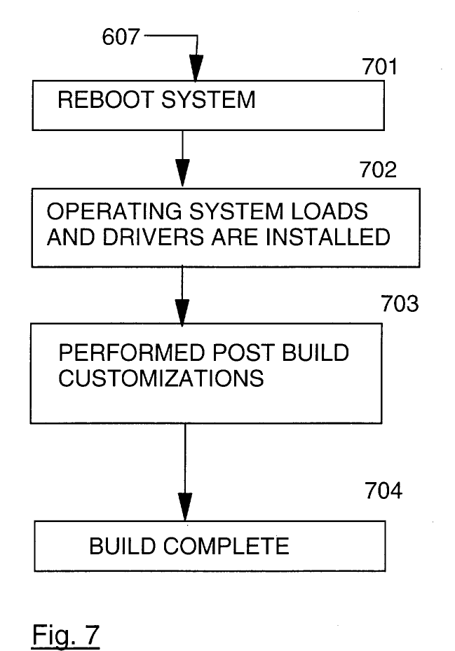

Referring to FIG. 6, in one embodiment, an image of a first system is created at a second system using Sysprep 601. The image is saved as a clone image. Characteristics of the second system are created using a build process program 602. A cloning tool clones 603 the image to the second system according to characteristics of the second system. Driver information locating drivers that are appropriate for the clone system is read 604. Needed drivers are loaded 606 into the primary partition of the second system. Sysprep.inf file is modified 607 according to predetermined requirements including display and multiprocessor settings. The second system is rebooted (FIG. 7) 701 which 702 loads the OS and installs the drivers. Post build customization 703 is performed to complete the clone build process.

Before cloning, using Windows Sysprep, prepare the source system 601, list the location of the repository for the drivers. (The driver path is listed in the sysprep.inf file.)

Clone the source system 603. For example, cloning can create a clone (replica) image and save it to any of: a partition in the cloning system, to a server (by network interconnection) via netbios disk or a Compact Disk (CD) for example. During a post clone routine, the control program calls “mtbchknt.exe” (that performs many of the novel steps of the invention). The mtbchkne.exe reads mrf.ini 604. The mrf.ini file is a response file created by the build process 605. This file contains information such as type/model specific information including the identification of drivers (driver names) required for the system. The Mtbchkne.exe program reads all the plug and play drivers and applications required by the target system 503. (see table 1 for an example, the listed drivers are at lines <5> to <8>). These drivers and applications will be downloaded from the server to the client. The drivers downloaded 606 to the system are based on the definition in the type/model support table 1 (found in the mtb.ini file). The type/model specific information in this table is copied to the response file (mrf.ini) for the build process. At that time the mtbchknt.exe downloads 606 the drivers to the temporary staging area (partition, Disk drive, network, other) then mtbchknt.exe will transfer each driver to the primary partition using the PowerQuest tool, pqaccd.exe used for writing to NTFS partitions in DOS. The drivers are downloaded in the Temporary staging area and placed on “c:\pnp” directory (also referred to as the driver repository) on the NTFS partition.

Any drivers listed under [common_pnp] in mrf.ini/mtb.ini are downloaded and placed on the client in c:\pnpdrvs\004, 005, 006. These drivers include such things as drivers for Network cards, modems, and mass storage devices that are needed on every system.

Also screen and multiprocessor configuration information is checked. Mtbchknt then checks the response file (mrf.ini) for the display (w2k/xp) and hal (xp only) keys in the mrf.ini file, downloads 607 the new sysprep.inf from the server, makes any required changes to that file (to identify where the drivers are), then copies it to c:\sysprep\ on the client (target) system.

During the next boot 701, sysprep runs and detects the new drivers added 702 to the system.

During the GUI portion of the build, c4ebcust is run and controls the post install routine 703. During the GUI, Config2k installs any other drivers, apps, or enhancements required by that type/model. The sysprep.inf is updated and stored on the client. It is updated to tell sysprep where the drivers are that have been added to the driver repository.

TABLE 1

| Windows 2000/XP Table Format (mtb.ini/mrf.ini): | |
|---|---|
| [1171-91*] | |
| model=ThinkPad I-Series 1300 | |
| preload=no | |
| image=000001 | |
| biosdate=20001222 | |
| biosdisk=spsdkw54 | |
| biosname=kwuf54ww | |
| setbios= | |
| bitsperp=16 | <1> |
| vrefresh=60 | <2> |
| xresolut=1024 | <3> |
| yresolut=768 | <4> |
| pnp1=vftpkw2k | <5> |
| pnp2=tpafkw2k | <6> |
| pnp3=mdltkw2k | <7> |
| pnp4=tracpt2k | <8> |
| numpnps=4 | <9> |

| d1=iseries | |
|---|---|
| o1=1 | |
| n1=I-Series Custom | |
| d2=dialer | |
| o2=1 | |
| n2=IGN Dialer | |
| d3=mobsetup | |
| o3=1 | |
| n3=Mobile IP Address | |
| d4=hal | <10> |
| o4=2 | <11> |
| n4=ACPI Multiprocessor PC | <12> |
| numdrivers=4 | |

TABLE 2

Server Format:
XP sysprep.inf repos:/ospwxp/%version%/sysprep.inf
XP driver repos:/wxpdrive/repos/pnp/<driver name>/
XP AutoConfig repos:/wxpdrive/repos/ac/<driver name>
XP “common_repos” location: /wxpdrive/repos/<driver name>/
(unchanged)
2000 sysprep.inf repos:/ospw2k/%version%/sysprep.inf
2000 driver repos:/w2kdrive/repos/pnp/<driver name>/
2000 AutoConfig repos:/w2kdrive/repos/ac/<driver name>/
2000 “common_repos” location: /w2kdrive/repos/<driver
name>/(unchanged)
Client Format 2000/XP:
Driver repos on client: c:\pnp\
Directory format: c:\pnp\001, 002, 003, 004, 005, 006, 007, etc.
Sysprep File Location: c:\sysprep\sysprep.inf

TABLE 3

Sysprep.inf Modifications and Format:
Display Settings:
(In mrf.ini)
bitsperp=32
vrefresh=75
xresolut=1024
yresolut=768
Apppend the following to sysprep.inf
[Display]
BitsPerPel=32
Vrefresh=75
Xresolution=1024
Yresolution=768
Multiprocessor Hal Update (XP Only):
(In mrf.ini)
d1=hal
o1=2
n1=ACPI Multiprocessor PC
Apppend the following to sysprep.inf
[Unattended]
UpdateHAL=“ACPIAPIC_MP,C:\Windows\inf\hal.inf”
Note: The position of the line should either be right under the
[Unattended] header (recommended) , or as the very last item in
the [Unattended] section of the file.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for creating a replica (clone) computer system program image, the method comprising the steps of:
preparing a first computer system for a cloning operation;
creating a component list comprising identifiers identifying desired components for a predefined group of computer systems, the group of computer systems comprising the first computer system, the component list further comprising a first identifier of a first component;
creating the clone image of the prepared first computer system;
transferring the clone image to a second computer system;
providing the component list to the second computer system;
using the first identifier in the component list to locate the first component; and
inserting the located first component into the transferred clone image on the second system.

2. The method according to claim 1 comprising the further step of removing components from the clone image before performing the step of transferring the clone image.

3. The method according to claim 1 wherein components comprise any one of application programs or device driver programs.

4. The method according to claim 3 wherein the component list comprises a version identification for the first component.

5. The method according to claim 1 wherein the preparing step comprises any one of loading an application, configuring the hardware or adding device drivers.

6. The method according to claim 1 wherein the group of computer systems is defined according to any one of a computer model or a computer type code.

7. The method according to claim 1 comprising the further steps of:
saving first information at a remote computer wherein the first information comprises any one of the clone image, the component list or the first component;
retrieving the saved first information from the remote computer; and
using the retrieved saved first information in any one of the transferring step, the providing step or the inserting step.

8. The method according to claim 1 wherein the creating the component list step further comprises selecting components based on component version number.

9. A computer program product for creating a replica (clone) computer system program image, the computer program product comprising a computer readable medium having computer readable program code therein comprising:
computer readable program code for preparing a first computer system for a cloning operation;
computer readable program code for creating a component list comprising identifiers identifying desired components for a predefined group of computer systems, the group of computer systems comprising the first computer system, the component list further comprising a first identifier of a first component;
computer readable program code for creating the clone image of the prepared first computer system;
computer readable program code for transferring the clone image to a second computer system;
computer readable program code for providing the component list to the second computer system;
computer readable program code for using the first identifier in the component list to locate the first component; and
computer readable program code for inserting the located first component into the transferred clone image on the second system.

10. The computer program product according to claim 1 wherein the computer program product further comprises computer readable program code for removing components from the clone image before performing the step of transferring the clone image.

11. The computer program product according to claim 1 wherein the components comprise any one of application programs or device driver programs.

12. The computer program product according to claim 13 wherein the component list comprises a version identification for the first component.

13. The computer program product according to claim 1 wherein the preparing computer readable program code further comprises any one of computer readable program code for loading an application, computer readable program code for configuring the hardware or computer readable program code for adding device drivers.

14. The computer program product according to claim 1 wherein the group of computer systems is defined according to any one of a computer model or a computer type code.

15. The computer program product according to claim 1 wherein the computer program product further comprises:
computer readable program code for saving first information at a remote computer wherein the first information comprises any one of the clone image, the component list or the first component;
computer readable program code for retrieving the saved first information from the remote computer; and
computer readable program code for using the retrieved saved first information in any one of the computer readable program code for transferring, the computer readable program code for providing or the computer readable program code for inserting.

16. The computer program product according to claim 1 wherein the computer readable program code for creating the component list further comprises computer readable program code for selecting components based on component version number.

17. A system for creating a replica (clone) computer system program image, the system comprising:
a preparor, preparing a first computer system for a cloning operation;
a list creator, creating a component list comprising identifiers identifying desired components for a predefined group of computer systems, the group of computer systems comprising the first computer system, the component list further comprising a first identifier of a first component;
a image creatoer, creating the clone image of the prepared first computer system;
an image transferor, transferring the clone image to a second computer system;
a list provider providing the component list to the second computer system;
an identifier user, using the first identifier in the component list to locate the first component; and
a component insertor, inserting the located first component into the transferred clone image on the second system.

18. The system according to claim 1 further comprising a component remover, removing components from the clone image before performing the step of transferring the clone image.

19. The system according to claim 1 wherein the preparor comprises any one of loading an application, configuring the hardware or adding device drivers.

20. The method according to claim 1 further comprising:
an information saver, saving first information at a remote computer wherein the first information comprises any one of the clone image, the component list or the first component;
an information retriever, retrieving the saved first information from the remote computer; and
a information user, using the retrieved saved first information in any one of the transferring step, the providing step or the inserting step.
